(19) United States
(12) Patent Application Publication
(10) Pub. No.: US 2023/0191772 A1
(43) Pub. Date: Jun. 22, 2023

(54) PLATE CYLINDER WITH REUSABLE ADHESION SURFACE

(71) Applicant: tesa SE, Norderstedt (DE)

(72) Inventors: Stefan Wulf, Mönchengladbach (DE); Norbert Grittner, Hamburg (DE)

(73) Assignee: tesa SE, Norderstedt (DE)

(21) Appl. No.: 17/996,266

(22) PCT Filed: Apr. 6, 2021
(86) PCT No.: PCT/EP2021/058886

§ 371 Date: Oct. 14, 2022

(30) Foreign Application Priority Data
Apr. 17, 2020 (EP) 20170083.8

(51) Int. Cl. B41F 27/12; B41M 1/04

(52) U.S. Cl. CPC B41F 27/1275; B41M 1/04

(57) ABSTRACT

A plate cylinder for multiple mounting of flexographic printing plates is provided. The plate cylinder has an outer circumferential surface and a longitudinal axis. It comprises an adhesion layer attached to the plate cylinder, the adhesion layer comprising a carrier sheet with a mounting surface side facing the plate cylinder and an adhesion surface side facing radially outwards in relation to the longitudinal axis; and a plurality of adhesion elements. Each of these adhesion elements includes an elongated body extending radially outwards in relation to the longitudinal axis and an end face for attaching the printing plate by an adhesive bond, wherein the end faces of the adhesion elements form the adhesion surface side.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/EP2021/058886, filed on Apr. 6, 2021, designating the United States of America, which in turn claims the benefit of priority under 35 U.S.C. §§ 119, 365 of European Patent Application No. 20170083.8, filed Apr. 17, 2020, the contents of which are relied upon and incorporated herein by reference in their entirety.

### FIELD OF THE DISCLOSURE

The present invention relates to an adhesion plate cylinder for flexographic printing plates using microstructures with adhesive properties. More specifically, the present invention relates to an adhesion plate cylinder with a reusable adhesion surface side for mounting a flexographic printing plate and a method for producing an adhesion plate cylinder with a reusable adhesion surface side for mounting a flexographic printing plate. The present invention also relates to a printing plate attachment means utilizing adhesion and a method of refurbishing a plate cylinder with such a printing plate attachment means. Further, the present invention relates to an adhesion printing plate and a printing process using an adhesion layer.

### BACKGROUND

In flexographic printing, plate cylinders are employed on which flexographic printing plates are mounted in order to print a desired pattern onto a substrate. The most widely used method for attaching a flexographic printing plate to a plate cylinder is the use of a double-sided adhesive tape. However, often difficulties occur when removing the tape from the plate cylinder, which results in residues left behind. Such residues later interfere during reuse of the plate cylinder and deteriorate the printing performance. Further, attaching the double-sided adhesive tape uniformly and without causing surface irregularities (e.g., air bubbles) that impair the printed image is a cumbersome manual operation.

US 3,425,347 discloses a printing plate including a rubber layer having an outer printing surface and an inner mounting surface formed by a pattern of spaced uniform projections which relieve tension and concavity of the printing surface when the layer is mounted and adhesively secured to a curved backing member. The projections comprising the mounting surface may be formed from a softer rubber than the printing surface so that they may readily yield and deform when the printing surface is subjected to excessive localized pressure.

US 2017/0009105 A1 describes pressure sensitive adhesive articles which have been surface modified by a plurality of non-pressure sensitive adhesive structures applied on the surface of the pressure sensitive adhesive by direct contact printing. This allows the pressure sensitive adhesive articles to be positionable or to be repositionable.

A more recent method involves the use of an adhesive attachment layer that includes an adhesive photopolymerizable composition to attach the printing plate to the printing cylinder (see WO 95/19267). The adhesive printing form attachment layer is able to maintain its adherent properties during continued use and re-use. In contrast to the double-sided adhesive tape that is usually attached to a plate cylinder at the printing site, such an adhesive attachment layer may be mounted to a plate cylinder at a manufacturing site. In this case, the plate cylinder may be transported between the manufacturing and printing site in order to be refitted.

One challenge for adhering a printing plate to a plate cylinder is the integrity of the adherence. On the one hand, the adherence between the printing plate and the plate cylinder has to be sufficient for preventing an unintended detachment during the printing process. When mounting the printing plate to the circumferential surface of the plate cylinder the printing plate is elastically bent. This bending and the elasticity of the printing plate result in a force that tries to revert the printing plate to its original flat shape. As a result, there is constantly a force acting on the connection between the printing plate and the plate cylinder that promotes the detachment of the printing plate.

On the other hand, the adherence between the printing plate and the plate cylinder should be moderate enough to allow an easy detachment of the flexographic printing plate without leaving residues behind, which result in a need for a cleaning process before mounting a new printing plate.

### SUMMARY OF THE DISCLOSURE

Thus, it is an objective of the present invention to provide a plate cylinder with a circumferential surface that allows for multiple attachments and detachments of flexographic printing plates. For this, the adhesive strength provided by this surface should be sufficiently strong to keep a printing plate in place during printing and at the same time allow for an easy detachment of the printing plate after printing without leaving residues behind that impair the attachment of the next printing plate. Another objective was to simplify the refurbishing process of the plate cylinder with a new surface for mounting and removing printing plates multiple times. Yet another objective was to facilitate cleaning of a plate cylinder with such a surface in order to remove residues or foreign matter from this surface (e.g., foreign objects, such as dust, or ink).

These objectives are addressed by the adhesion plate cylinder and the method to prepare such an adhesion plate cylinder according to the subject matter of the independent claims. Preferred embodiments are specified in the claims dependent thereon.According to an aspect of the disclosure, an adhesion plate cylinder for multiple applications and removals of flexographic printing plates is provided that includes: a plate cylinder, the plate cylinder having an outer circumferential surface and a longitudinal axis; and an adhesion layer. The adhesion layer is attached to the plate cylinder and includes: a carrier sheet with a mounting surface side facing the plate cylinder and an adhesion surface side facing radially outwards in relation to the longitudinal axis, and a plurality of adhesion elements. Each adhesion element includes an elongated body extending radially outwards in relation to the longitudinal axis and an end face for attaching a printing plate by adhesion. Further, the end faces of the adhesion elements define the adhesion surface side.

According to an aspect of the disclosure, a method of producing an adhesion plate cylinder with a reusable adhesion surface side for mounting a flexographic printing plate is provided, the method including the steps: providing a plate cylinder, the plate cylinder comprising a longitudinal axis and an outer circumferential surface; and mounting an adhesion layer to the plate cylinder using an adhesive bond so that a carrier sheet of the adhesion layer faces the plate cylinder. A plurality of adhesion elements define the reusable adhesion surface side and extend from the carrier sheet radially outwards in relation to the longitudinal axis. Further, each of the adhesion elements includes an end face for attaching a flexographic printing plate by adhesion.

According to an aspect of the disclosure, a printing plate attachment for removably attaching a printing plate to an adhesion plate cylinder is provided that includes an adhesion layer that comprises: a carrier sheet with a mounting surface side and an adhesion surface side; and a plurality of adhesion elements. Each adhesion element includes an elongated body protruding from the carrier sheet and an end face for attaching a printing plate by adhesion. The end faces of the adhesion elements define the adhesion surface side. Further, the adhesion layer is formed as a foil.

According to an aspect of the disclosure, an adhesion printing plate is provided that includes: a printing plate; and an adhesion layer. The adhesion layer comprises: a carrier sheet with a mounting surface side facing the printing plate and an adhesion surface side facing away from the printing plate; and a plurality of adhesion elements. Each adhesion element includes an elongated body protruding from the carrier sheet and an end face for attachment to a plate cylinder by adhesion. Further, the end faces of the adhesion elements define the adhesion surface side.

According to an aspect of the disclosure, a printing process using an adhesion layer is provided that includes: providing an adhesion layer that comprises: a carrier sheet with a mounting surface side and an adhesion surface side, and a plurality of adhesion elements; mounting the mounting surface side of the carrier sheet to one of a printing plate and a plate cylinder by an adhesive bond; attaching the adhesion surface side to the other one of the printing plate and the plate cylinder by an adhesive bond; and performing a printing step using the printing plate, the performing step conducted after the steps of mounting and attaching. Each adhesion element includes an elongated body protruding from the carrier sheet and an end face. Further, the end faces of the adhesion elements define the adhesion surface side.

### BRIEF DESCRIPTION OF THE DRAWINGS

The following figures illustrate preferred embodiments of the present invention. These embodiments are not to be construed as limiting but merely for enhancing the understanding of the invention in context with the description. In these figures, same reference signs refer to features throughout the drawings of different embodiments that have the same or an equivalent function and/or structure. For reasons of conciseness, a repetitive description of these components is generally omitted.

FIG. 1 is a side view of an adhesion plate cylinder according to an embodiment of the present invention including an adhesion layer;

FIG. 2 shows a cross-section of the adhesion plate cylinder illustrated in FIG. 1 along line A-A;

FIG. 3 is a detailed view of an embodiment of an adhesion element extending from a carrier sheet; and

FIG. 4 illustrates an arrangement of multiple adhesion elements of an embodiment of an adhesion layer.

### DETAILED DESCRIPTION

The inventors had the idea to use the adhesive properties of microstructures and in particular fibrillar microstructures for attaching a printing plate to a plate cylinder. These microstructures act as a dry adhesive and have been discussed in the prior art. For example, Kamperman et al. discuss such “Functional Adhesive Surfaces with ‘Gecko’ Effect: The Concept of Contact Splitting” in Advanced Engineering Materials 2010, 12, No.5 (DOI: 10.1002/adem.201000104).

As a result, the disclosure provides an adhesion plate cylinder for multiple applications and removals of flexographic printing plates. The adhesion plate cylinder includes a plate cylinder, the plate cylinder having an outer circumferential surface and a longitudinal axis. The adhesion plate cylinder also includes an adhesion layer, the adhesion layer being attached to the plate cylinder and comprising a carrier sheet with a mounting surface side facing the plate cylinder and an adhesion surface side facing radially outwards in relation to the longitudinal axis. The adhesion layer further comprises a plurality of adhesion elements. Each of these adhesion elements includes an elongated body extending radially outwards in relation to the longitudinal axis and an end face for attaching the printing plate by an adhesive bond, wherein the end faces of the adhesion elements form the adhesion surface side.

The adhesion surface side is formed by the end faces of the adhesion elements. Each of these end faces is arranged at the end of a corresponding elongated body extending radially outwards so that the end faces are facing radially outwards. The end faces are basically flush with a plane parallel and at a distance to the carrier sheet (e.g., in a state in which the carrier sheet is laid flat). The distance corresponds to the length of the elongated bodies. The carrier sheet in a preferred embodiment may comprise a foamed material in order to calibrate or adjust hardness and compressibility.

The mounting surface side facing the plate cylinder may be attached using an adhesive layer or may have an adhesive film on its surface.

With the above-described configuration, a flexographic printing plate can reliably adhere to the end faces of the adhesion plate cylinder’s adhesion layer. More specifically, an adhesion force established between the end face of the adhesion elements and the flexographic printing plate securely holds the printing plate to the adhesion plate cylinder.

The adhesion plate cylinder is preferably formed as a sleeve that is mountable onto a cylinder of a printing machine. Alternatively, the plate cylinder may be formed as a cylinder of a printing machine.

Further, the edges and corners of a flexographic printing plate are prevented from an unintended detachment during the printing process due to the flexibility of the adhesion elements. Since the end faces of the adhesion elements are located at the end of their respective elongated bodies, they are provided with sufficient flexibility to ensure a close contact between the end faces of the adhesion elements and a flexographic printing plate.

Even if the flexographic printing plate tends to bend away from the adhesion plate cylinder, aforenoted flexibility of the adhesion elements will help in preventing detachment of the printing plate. This flexibility also prevents an uneven printing pressure to be exerted onto the printing plate while being in contact with the printing substrate. Further, this contact with the printing substrate supports the bond between the flexographic printing plate and the end faces of the adhesion elements by regularly “refreshing” this bond while the adhesion plate cylinder is rotated in a printing machine.

Nonetheless, bending a flexographic printing plate to a certain degree (e.g., beyond a detachment threshold), and in particular backwards, allows for stripping off the printing plate from the adhesion plate cylinder. Thus, peeling off the printing plate from the adhesion plate cylinder’s adhesion layer is a convenient way to detach the flexographic printing plate. Due to the reusability of the adhesion layer, there is no need for scraping of any residues, in particular since peeling off the flexographic printing plate from the adhesion layer may be performed with blunt tools. This prevents the adhesion layer and the adhesion elements from being damaged.

It is believed that the adhesion between the end faces of the adhesion elements and a flexographic printing plate is established by van der Waals forces and electrostatic interaction. For this reason and due to the structural arrangement of the adhesion elements, there are essentially no complications due to air bubbles enclosed between the flexographic printing plate and the adhesion layer. The air bubbles are a common nuisance since they cause an unevenness in the printing surface. The unevenness does not only lead to problems with a printing result due to its extension in a radial direction of the adhesion plate cylinder but also in a circumferential direction. Further, a distortion of the printing pattern extends beyond the region of an enclosed bubble. In contrast, the adhesion elements of the present disclosure basically prevent air from being trapped since it can dissipate between the elongated bodies of these elements. Therefore, it is also an objective of the present invention to overcome the deterioration of printing results due to above mentioned enclosed air bubbles.

It should be noted that reliable adhesion is also achieved for elevated temperatures that occur during printing and despite the presence of solvents as part of the ink used to print onto a substrate. Further, printing residues and foreign objects may easily be wiped off the adhesion layer before its use or reuse, for example with water, in particular together with soap.

The plurality of adhesion elements forms a microstructure surface on the adhesion surface side. Although it is preferred to have the microstructure surface evenly distributed over the surface of the adhesion layer, an uneven distribution may still be used. The elongated body of the adhesion elements may have a diameter of 10 to 80 microns, preferably 20 to 70 microns, and a height of 50 to 150 microns, preferably 80 to 120 microns.

These dimensions are the preferred diameters and heights of the adhesion elements. They represent dimensions that allow for the adhesive strength and flexibility of the adhesion layer resulting in the advantages described above. The range of diameters further enable a density of adhesion elements that is particularly advantageous for mounting the edges and corners of a flexographic printing plate to the adhesion plate cylinder.

Further, the thickness of the carrier sheet is preferably between 200 to 600 microns in order to provide sufficient support for the adhesion elements.

The elongated body may have a flared head portion with a maximum diameter of 30 to 80 microns, preferably 35 to 70 microns, wherein the head portion preferably has a substantially flat or concave end face. Providing the elongated body with a flared head portion, wherein the end face of the elongated body for attaching a flexographic printing plate is larger than at least an intermediate portion of the elongated body, increases the flexibility of the adhesion elements without compromising the adhesive strength provided by these elements. Further, the flared head portion enhances the adaptability of the end faces to the surface of a flexographic printing plate that is attached to the adhesion surface side. It is also possible to enhance the flexibility of the flared portion even further by providing the end face with a concavity. This results in a decrease of material thickness in the peripheral region of the end face, which reduces the stiffness and enhances the adaptability of the end face to the topography of a flexographic printing plate to be attached to the end faces of the adhesion layer.

The waisted shape of the adhesion elements resulting from the flared head portion also has the advantage of preventing a peel-off effect, i.e., a detachment of the adhesion elements starting from one peripheral side of their end face. Due to the waisted shape, the adhesion elements generally stay attached if a peeling motion occurs. Despite the peeling motion, the pulling force finally detaching an adhesion element generally acts in the midpart of and in a normal direction to the end face.

In particular, the elongated body adjacent to the head portion comprises a neck portion with a diameter of 10 to 35 microns, preferably 15 to 30 microns. In other words, the neck of the flared design described above preferably has these diameters at the neck portion in order to enhance the flexibility of the adhesion elements. Preferably, the diameter of the neck portion is smaller than the diameter of the base portion of an adhesion element, where it extends from the carrier sheet of the adhesive layer. An elongated body of an adhesion element may have its maximum diameter on the side of the base or on the side of the head. Preferably, it is on the side of the base since this facilitates the production of the adhesion elements using casting techniques. The change in diameter is preferably continuous. In other words, the change in diameter results in a frustoconical shape on either or both sides of the neck. The profile of this frustoconical shape may essentially be formed by a straight-line but is preferably curved and most preferably a concave curve.

In terms of density, the carrier sheet may comprise 3,000 to 300,000, preferably 10,000 to 100,000, even more preferably 20,000 to 50,000 and most preferably 25,000 to 30,000 adhesion elements per square centimeter. In other words, any of these numbers of adhesion elements may extend from the carrier sheet per square centimeter to provide the desired adhesive strength for attaching a flexographic printing plate.

The desired adhesive strength of the adhesion layer may be provided by the end faces of the adhesion elements covering 30% to 50%, preferably 35% to 40%, of the surface of the carrier sheet. This desired adhesive strength keeps a flexographic printing plate attached during printing while allowing the removal of the flexographic printing plate by bending it away from the adhesion plate cylinder by hand.

The adhesion plate cylinder may further comprise a silicone layer, the silicone layer being arranged between the adhesion layer and the plate cylinder and being mounted on both sides with an adhesive bond, wherein the adhesive bond between the silicone layer and the plate cylinder is preferably provided by a double-sided adhesive film. In its function as an adhesive bond the term “double-sided adhesive film” includes different shapes of the film material, as for example tapes and stripes.

The silicone layer has a damping effect and supports the adhesion layer. It may also be used to prepare the plate cylinder for the adhesion layer so that the circumferential surface of the plate cylinder including the silicone layer is levelled to a degree so as not to interfere with the adhesion properties of the adhesion surface side. In other words, the silicone layer may assist in the end faces of the adhesion elements being flush with a virtual circumferential plane extending around the adhesion plate cylinder. This virtual circumferential or cylindrical plane about the longitudinal axis of the plate cylinder (coinciding with the longitudinal axis of the adhesion plate cylinder) also forms the plane of attachment for a flexographic printing plate. Since the silicone layer does not have to be changed each time a printing plate is replaced but instead at least lasts as long as the adhesion layer, it is preferably attached to the outer surface of the plate cylinder using a double-sided adhesive film. Although the double-sided adhesive film is harder to remove when refurbishing a plate cylinder or an adhesion plate cylinder with a new adhesion layer, it provides a very reliable and durable attachment of the silicone layer.

The adhesion plate cylinder may further comprise a double-sided adhesive film or double-sided adhesive layer, wherein the double-sided adhesive film or double-sided adhesive layer is preferably made of silicone and is arranged between the adhesion layer and the plate cylinder, and the double-sided adhesive layer is particularly a foam layer. Similar to the attachment of the silicone layer to the plate cylinder, a double-sided adhesive film may likewise provide a durable and reliable attachment of the adhesion layer to the plate cylinder or, if present, the silicone layer. If a double-sided adhesive layer is used that is made of silicone, it may have the same advantageous properties that have already been described above in relation to the silicone layer. Further, using a double-sided adhesive layer having a foam structure allows for adjusting the adhesion plate cylinder to a predetermined elasticity or compressibility.

The adhesion layer is preferably made of a polymer, in particular siloxanes, such as polyvinylsiloxanes, polydimethylsiloxanes and siloxane copolymers, polyurethane, or an acrylate. The polymers and copolymers disclosed herein can be prepared following typical crosslinking procedures including addition, condensation and radical crosslinking reactions. When aiming at the preparation of, e.g., siloxanes, the monomers are not restricted to dimethyl siloxane, but other monomers such as methyl-phenyl-siloxane monomers can be used as well. The siloxane polymers are thus not limited to any particular type of siloxanes, just as the polyurethane or the acrylate may be chosen from a whole set of different polymers. One important aspect of the polymers discussed herein is that they are sufficiently crosslinked to provide the adhesion layer and the adhesion elements with elastic (rather than viscoelastic) properties. These polymeric materials further provide properties that allow for integrally forming the carrier sheet and the plurality of adhesion elements extending therefrom. Further, polyvinylsiloxane has shown to be an excellent material for providing the features described in this disclosure.

The disclosure further provides a method for producing an adhesion plate cylinder with a reusable adhesion surface side for mounting a flexographic printing plate, wherein the method comprises the steps of: providing a plate cylinder comprising a longitudinal axis and an outer circumferential surface; and mounting an adhesion layer to the plate cylinder using an adhesive bond so that a carrier sheet of the adhesion layer faces the plate cylinder and adhesion elements forming the reusable adhesion surface side extending from the carrier sheet extend radially outwards in relation to the longitudinal axis, wherein each one of the adhesion elements includes an end face for attaching the printing plate by an adhesive bond.

With this method, an adhesion plate cylinder with a reusable adhesion surface can be provided at the production site. In other words, it is not necessary to produce a new adhesion plate cylinder or refurbish a run-down plate cylinder or adhesion plate cylinder away from the printing site. Instead, at least refurbishing of such a plate cylinder can be performed at the site of the printing equipment. This not only saves cost, but also allows to react more readily when replacing a run-down plate cylinder becomes necessary.

As described above, the adhesion layer comprises a carrier sheet and adhesion elements extending on one side from the carrier sheet. In relation to the plate cylinder, the mounting surface side of the carrier sheet is on the side of the adhesion layer facing the plate cylinder (i.e., radially inwards) whereas the adhesion elements are on the adhesion surface side of the adhesion layer facing radially outwards (i.e., facing a printing plate to be attached).

Using an adhesive bond, such as an adhesive bond provided by a double-sided adhesive film or a pressure sensitive adhesive, provides a durable and reliable attachment of the mounting surface side of the adhesion layer to the plate cylinder. In this context, the attachment by adhesion (i.e., van der Waals forces and electrostatic interaction) that takes place on the adhesion surface side of the adhesion layer allows for multiple applications and removals of the flexographic printing plate. In contrast, the adhesive bond acting between the plate cylinder and the carrier sheet of the adhesion layer is configured for a single use (i.e., one attachment and one removal). In other words, the adhesive bond is not intended for its reuse. For example, the adhesive bond, the adhesion layer, the outer surface of the plate cylinder and/or another layer that may be present on the outer side of the plate cylinder may be damaged upon removal of the adhesion layer from the plate cylinder. Further, residues of the adhesive bond may be left behind upon removal of the adhesion layer being mounted to the plate cylinder using such an adhesive bond. Further, the adhesive bond may be established by an adhesive surface of the adhesion layer, an adhesive surface of the plate cylinder, or a double-sided adhesive film. In other words, the mounting surface side of the adhesion layer and/or the outer surface of the plate cylinder or another layer mounted to the plate cylinder is configured as an adhesive surface, wherein the adhesive of this adhesive surface is configured to establish a (permanent) adhesive bond. Likewise, the adhesive bond may be provided by a double-sided adhesive film, wherein an adhesive is applied to opposite sides of the film for establishing a (permanent) adhesive bond.

The method may further comprise the step of mounting a silicone layer to the plate cylinder before mounting the adhesion layer to the plate cylinder. The silicone layer may have an adhesive surface for mounting the adhesion layer. This step provides the advantages to a plate cylinder that have already been discussed above in more detail and are achieved by including a silicone layer as part of the plate cylinder. Similar to the description of above, mounting the silicone layer may include establishing an adhesive bond using an adhesive surface of the silicone layer, an adhesive surface of the plate cylinder, or a double-sided adhesive film. Likewise, mounting the adhesion layer may include establishing an adhesive bond using an adhesive surface of the adhesion layer, an adhesive surface of the silicone layer, or a double-sided adhesive film. Using a double-sided adhesive film provides for a particularly durable and reliable adhesive bond. Further, this type of attachment does not require any extra training of personnel at the printing site since it is frequently used at such sites and all the tools necessary are readily available.

The disclosure further provides a printing plate attachment means comprising an adhesion layer, preferably an adhesion layer as described above, in particular in relation to the adhesion plate cylinder. The adhesion layer is for removably attaching a printing plate to an adhesion plate cylinder. The adhesion layer comprises a carrier sheet with a mounting surface side and an adhesion surface side. It further comprises a plurality of adhesion elements, wherein each adhesion element includes an elongated body protruding from the carrier sheet and an end face for attaching the printing plate by an adhesive bond, wherein the end faces of the adhesion elements form the adhesion surface side. The adhesion layer is preferably formed as a foil.

The adhesion layer of the printing plate attachment means may be formed as a mounting sleeve that is configured to be mounted onto a plate cylinder. Preferably, the mounting sleeve is configured to be advanced onto the plate cylinder so that the printing plate attachment means forms the circumferential outer surface of an adhesion plate cylinder. For this, the mounting sleeve is pushed or pulled in the direction of the plate cylinder’s longitudinal axis. In order to fixate the mounting sleeve to the outer surface of the plate cylinder, the mounting sleeve may be stretched and/or shrunk during installation so as to be retained on the plate cylinder by elastic and frictional forces. Alternatively or additionally, the mounting sleeve may be held in position using a form fit between structural features of the plate cylinder and the mounting sleeve.

The present disclosure further provides a method of refurbishing a plate cylinder by applying a printing plate attachment means, preferably a printing plate attachment as detailed above, to the plate cylinder.

In addition, the present disclosure provides an adhesion printing plate. The adhesion printing plate comprises a printing plate and an adhesion layer. The adhesion layer is preferably configured as described above and includes a carrier sheet with a mounting surface side facing the printing plate and an adhesion surface side facing away from the printing plate. The adhesion layer also includes a plurality of adhesion elements, wherein each adhesion element comprises an elongated body protruding from the carrier sheet and an end face for attachment to a plate cylinder by an adhesive bond, wherein the end faces of the adhesion elements form the adhesion surface side.

Further, the present disclosure provides a printing process using an adhesion layer, preferably an adhesion layer as described in more detail above. The adhesion layer comprises a carrier sheet with a mounting surface side and an adhesion surface side, and a plurality of adhesion elements. Each adhesion element includes an elongated body protruding from the carrier sheet and an end face, wherein the end faces of the adhesion elements form the adhesion surface side. The printing process comprises the steps of mounting the mounting surface side of the carrier sheet to one of a printing plate and a plate cylinder by an adhesive bond; attaching the adhesion surface side to the other one of the printing plate and the plate cylinder by an adhesive bond; and, after performing the mounting and attachment steps, performing a print using the attached printing plate.

The skilled person will appreciate that additional layers may be arranged between the plate cylinder and the adhesion layer without departing from above-described configurations. In other words, a film or layer may face or be attached to another film, layer, or the plate cylinder while being in contact or not with said film, layer, or plate cylinder, respectively. If not being in contact, the film or layer faces or is attached to another film, layer, or the plate cylinder via yet another film or layer.

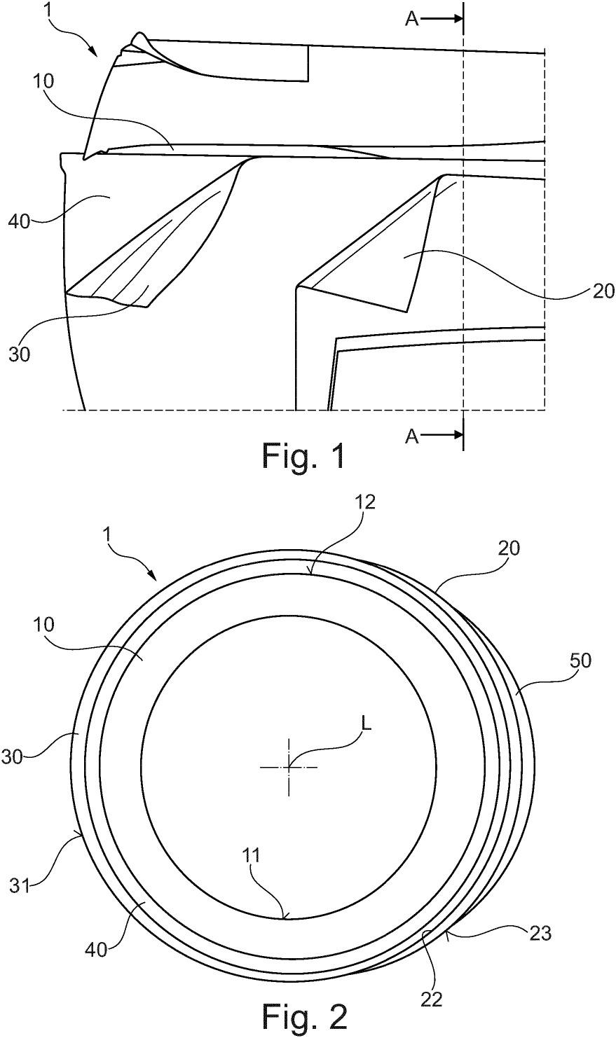

Referring now to FIG. 1, this figure shows an exemplary configuration of an adhesion plate cylinder 1 comprising a reusable adhesion layer 20 and a plate cylinder 10. As shown in FIG. 2, the plate cylinder 10 is preferably formed as a sleeve that comprises an inner circumferential surface 11 and an outer circumferential surface 12. The plate cylinder 10 has a longitudinal axis L which also represents the longitudinal axis of the adhesion plate cylinder 1 and the axis of rotation during printing when the adhesion plate cylinder 1 is installed on a printing cylinder of a printing machine (not shown). Accordingly, the plate cylinder 10 is preferably configured to be mounted as a plate cylinder sleeve on a printing cylinder of a printing machine (not shown). Alternatively, the plate cylinder may also be configured as a printing cylinder of a printing machine.

Initially, a double-sided adhesive film 40 may be mounted to the outer circumferential surface 12 of the plate cylinder 10. In the exemplary embodiment of a plate cylinder 10 illustrated in FIG. 2, the side of the double-sided adhesive film 40 facing radially outwards is for mounting a silicone layer 30. Such a silicone layer 30 functions as a damping element and provides compliance to the plate cylinder 10 that fosters a uniform distribution of printing pressure. Instead of using a double-sided adhesive film 40, an adhesive may be applied to the outer circumferential surface 12 of the plate cylinder 10 or a layer to be mounted to this surface 12, such as the silicone layer 30.

The silicone layer 30 may further be used for leveling the outer circumferential surface 12 of the plate cylinder 10. In such a case, the silicone layer 30 serves to provide a more accurate circular cylindrical outer surface for the next layer attached thereto. In other words, the silicone layer 30 enhances the uniformity of the cylindrical shape, i.e., it approximates the cross-section of a circle. This outer surface of the silicone layer 30 is preferably an adhesive surface 31 similar to the adhesive surface of a double-sided adhesive film.

As shown in the exemplary embodiment of FIG. 2, the adhesive surface 31 may then be used to attach an adhesion layer 20. The adhesion layer 20 extends at least along a section of the outer circumferential surface 12 of the silicone layer 30. Such a partial extension along the outer circumferential surface 12 of the silicone layer 30 or plate cylinder 10 shown in FIG. 2 provides a particularly efficient use of an adhesion layer 20. For example, the adhesion layer 20 may be adapted to the flexographic printing plates 50 to be mounted to the adhesion plate cylinder 1. This makes it easier for a user to recognize on which part of an adhesion plate cylinder 1 a flexographic printing plate 50 is to be mounted for a printing job.

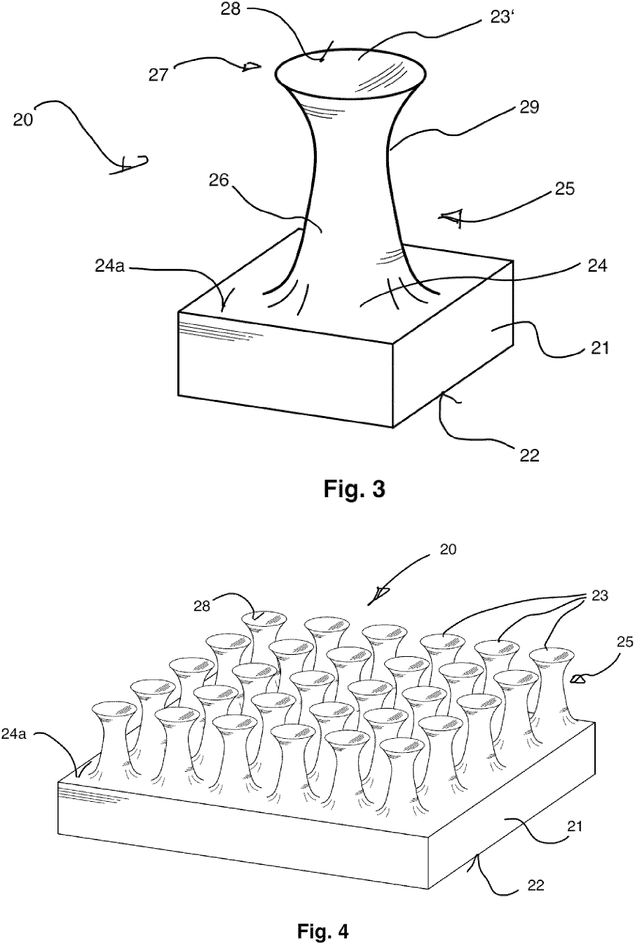

In particular, such an adhesion layer 20 (as shown in FIG. 2), which is adapted in its dimensions to a flexographic printing plate 50 (i.e., it has at least the size of the flexographic printing plate 50), may further have a varying density of adhesion elements 25, as shown in FIGS. 3 and 4. More specifically, a higher density of adhesion elements 25 may be provided in the region, where the edges and corners of a flexographic printing plate 50 are to be arranged upon mounting. Nonetheless, using an adhesion layer 20 with a uniform distribution or density of adhesion elements 25 facilitates handling of the adhesion layer 20 and can be adapted to different sizes of flexographic printing plates 50. Further, an adhesion layer 20 with a uniform density of adhesion elements 25 can be provided as an adhesion layer web that can be cut to a desired size (not shown). The adhesion elements 25 preferably protrude from one surface side of a carrier sheet 21, as shown in FIGS. 3 and 4. The adhesion elements 25 and the carrier sheet 21 form the adhesion layer 20 (see FIGS. 1 and 2) and are preferably integrally formed.

In terms of density, the carrier sheet 21 (see FIGS. 3 and 4) may comprise 3,000 to 300,000, preferably 10,000 to 100,000, even more preferably 20,000 to 50,000, and most preferably 25,000 to 30,000 adhesion elements 25 per square centimeter to provide the desired adhesive strength for attaching a flexographic printing plate 50. This density provides an adhesive strength that keeps a flexographic printing plate 50 attached during printing while allowing the removal of the flexographic printing plate 50 by bending it away from the adhesion plate cylinder 1, wherein the removal may be performed by hand.

The skilled person will appreciate that providing an adhesion layer 20 over the entire circumference of a plate cylinder 10 enhances the flexibility in terms of the size of flexographic printing plates 50 that can be attached to the plate cylinder 10.

The configuration of an adhesion plate cylinder 1 (see FIGS. 1 and 2) comprising at least an adhesion layer 20 and a plate cylinder 10 is configured for multiple applications and removals of flexographic printing plates 50. In other words, a change or refurbishment of the adhesion layer 20 may only be necessary after a plurality of printing jobs have been performed. For this reason, the adhesion layer 20 and/or any other layer(s) between the plate cylinder 10 and the adhesion layer 20 (if present) is/are preferably attached to the plate cylinder 10 using a double-sided adhesive film. Such a double-sided adhesive film provides an adhesive bond between these layers that withstands multiple printing jobs as well as multiple applications and removals of flexographic printing plates 50. The adhesive bond is particularly configured not to be affected by water as well as solvents or additives used for printing or cleaning the plate cylinder 10. An adhesive bond is to be understood as being intended for a long lasting or permanent fixation. As a result, a removal of a layer that has been fixated by such an adhesive bond at least likely results in permanent damage to the adhesive, which does not allow for attachment and fixation of a new layer. In other words, before an attachment of a new layer, a new adhesive has to be provided for forming a new adhesive bond.

Turning again to FIG. 3, this figure shows for the sake of explanation a section of an adhesion layer 20 with only one adhesion element 25. As described above, the adhesion layer 20 comprises a carrier sheet 21 and an adhesion element 25. The adhesion element 25 extends from a base surface 24a of the carrier sheet 21. The side opposite to the side of the base surface 24a forms a mounting surface side 22. The mounting surface side 22 may have adhesive properties for being mounted to a plate cylinder 10. In a mounted state, the mounting surface side 22 faces or is in contact with the plate cylinder 10 (e.g., directly or indirectly via another layer such as a double-sided adhesive film).

The thickness of the carrier sheet 21, as shown in FIGS. 3 and 4, is preferably between 200 to 600 microns in order to provide sufficient support to the adhesion elements 25 and sufficient flexibility for its application to the plate cylinder 10. For the reasons given in more detail above, the adhesion layer 20 is preferably made of a polymer, in particular polysiloxane, polyurethane, or an acrylate. Also, the adhesion layer 20 is preferably integrally formed, i.e., the adhesion elements 25 and the carrier sheet 21 form one continuous piece of material.

On the side of the adhesion layer 20 opposite to the mounting surface side 22 is the base surface 24a and adhesion surface side 23, as shown in FIGS. 3 and 4. In a mounted state of the adhesion layer 20, a plurality of adhesion elements 25 extend from this base surface 24a outwards in a radial direction of the plate cylinder 10. Each of these adhesion elements 25 comprises an elongated body 26 extending from the base surface 24a. The elongated body 26 may have a size or diameter of 10 to 80 microns, preferably 20 to 70 microns, and a length of 50 to 150 microns, preferably 80 to 120 microns.

At the end of the elongated body 26 is a head portion 27, as shown in FIG. 3. The head portion 27 comprises an end face 28 that faces radially outwards. Each surface 23′ of the end faces 28 of the adhesion elements 25 forms part of the adhesion surface side 23 of the adhesion layer 20. In other words, the accumulated surface of the end faces 28 of the adhesion elements 25 form the adhesion surface side 23 (see FIG. 4). Due to this arrangement, the end faces 28 only partially cover the surface of an adhesion layer 20. In particular, the adhesion elements 25 cover 30% to 50%, preferably 35% to 40%, of the surface of the carrier sheet 21 or adhesion layer 20.

As illustrated in FIG. 3, an adhesion element 25 may further comprise a neck portion 29, i.e., a portion with a minimum diameter along the elongated body 26 of the adhesion element 25. Preferably, the diameter of the elongated body 26 is increasing on both sides of the neck portion 29. The neck portion may have a diameter of 10 to 35 microns, preferably 15 to 30 microns.

On the side radially outwards in relation to the neck portion 20, the head portion 27 has a flared or frustoconical shape. As illustrated in FIG. 3, this flared shape tapering from the end face 28 towards the center of the plate cylinder 10 preferably has a curved profile. Nonetheless, the profile of the flared head portion 27 may also comprise at least one straight line. The flared head portion may have a maximum diameter of 30 to 80 microns, preferably 35 to 70 microns. If present, the same applies to a section radially inwards in relation to the neck portion 29 and tapering radially outwards. Alternatively, the adhesion elements 25 may comprise only one of these tapering sections. In such an embodiment, the adhesion element 25 does not comprise a neck portion 29.

FIGS. 3 and 4 show an embodiment of adhesion elements 25 having a size (e.g., diameter) at their base, i.e., at the base surface 24a, that is larger than a size of the end face 28. Although the base 24 and/or the end face 28 preferably have a substantially circular cross-section, any other geometry is possible. As already described above, the size of the base 24 of the elongated body 26 extending from the carrier sheet 21 is preferably larger than the size of the end face 28 for reasons of an efficient production since it allows to use casting techniques.

As previously described, an adhesion element 25 comprising the flared head portion 27 has the advantage to increase the flexibility of the elongated body 26. This is particularly the case if a neck portion 29 is present. At the same time, such a configuration still provides a rather large adhesion surface side 23′ of the end face 28 due to the increase in diameter of the head portion 27 in a direction radially outwards. Further, the flared geometry of the head portion 27 increases the compliance of the outer circumference of the end face 28, i.e., it enhances the flexibility of the end face’s periphery. This results in an enhanced adaptation to a topography of a flexographic printing plate 50 mounted to the adhesion surface side 23 (i.e., the sum of the surfaces 23′ of the face ends 28 of all adhesion elements 25).

Alternatively or additionally, the end faces 28 may be formed concave instead of flat for increasing the flexibility of the periphery of the end faces 28. This also results in an enhanced compliance of the end face 28 to a topography of a flexographic printing plate 50 and is caused by a reduced thickness of material at the rim of the concave end face 28. In contrast, an increased stiffness may be achieved by providing the end faces 28 with a convex shape.

FIG. 4 also illustrates a section of an adhesion layer 20. In contrast to FIG. 3, the section illustrated in FIG. 4 shows a plurality of adhesion elements 25 extending from a carrier sheet 21. As illustrated, the plurality of adhesion elements 25 is preferably arranged in an array, wherein the adhesion elements 25 are spaced at uniform distances from each other. As indicated, the sum of the surfaces 23′ of the end faces 28 form the adhesion surface side 23 of the adhesion layer 20. This adhesion surface 23 provides sufficient adhesion strength used for mounting a flexographic printing plate 50. This adhesion strength is provided by van der Waals forces and electrostatic interaction, which has already been discussed in more detail previously.

Although in the embodiments described above the adhesion layer 20 is mounted onto a plate cylinder 10 so that the adhesion elements 25 face radially outwards for attaching a flexographic printing plate 50, it is also possible to mount an adhesion layer 20 to the backside of a printing plate 50 so that the end faces 28 of the adhesion elements 25 face backwards. More specifically, the mounting surface side 22 of the carrier sheet 21 is fixed to the backside of the printing plate 50 via an adhesive bond. Mounted to each other, the adhesion layer 20 and the printing plate 50 form an adhesion printing plate (not shown). It should be noted that at least one further layer may be sandwiched between the printing plate 50 and the adhesion layer 20 such as the previously described silicone layer 30. The adhesive layer 20, the printing plate 50, and any layer interposed therebetween may have characteristics and properties described above in relation to the previous embodiments.

For mounting this adhesion printing plate to a plate cylinder 10 (i.e., a sleeve or a cylinder of a printing machine) (see FIG. 2), the end faces 28 of the adhesion printing plate’s adhesion elements 25 are brought into contact with an outer circumferential surface 12 of a plate cylinder 10. This contact results in an attachment of the adhesion printing plate by van der Waals forces and electrostatic interaction with above-noted advantages. In order to enhance the adhesion forces acting between the adhesion elements 25 of the adhesion printing plate’s adhesion layer 20 and the outer circumferential surface 12 of the plate cylinder 10, the outer circumferential surface 12 of the plate cylinder 10 has a smooth surface. The same applies to the flexographic printing plate 50 of the embodiments in relation to an adhesion plate cylinder 1 disclosed above.

The adhesion layer 20 of the present disclosure functions as a printing plate attachment means. This printing plate attachment means serves for attaching a printing plate 50 to a plate cylinder 10, wherein the printing plate attachment means is mounted to one of the printing plate 50 and the plate cylinder 10 via an adhesive bond or another method configured for permanent fixation. To the other one of the printing plate 50 and the plate cylinder 10 the printing plate attachment means is attached via the surface interaction between the end faces 28 of the adhesion elements 25 and the other one of the printing plate 50 and the plate cylinder 10 (i.e., the van der Waals forces and electrostatic interaction).

Preferably, the printing plate attachment means is formed as a foil. This foil may be integrally formed, or be a compound of multiple foils mounted to each other. In any case, the adhesion layer of the printing plate attachment means is preferably integrally formed (see description above). If being formed as a compound, another layer may be the aforenoted silicone layer 30.

Further, the printing plate attachment means may be formed as a sleeve so that it can be advanced onto a plate cylinder 10 during mounting. In other words, the adhesion layer may be pushed and/or pulled onto the plate cylinder 10. Permanent attachment or fixation may be achieved by an adhesive, in particular an adhesive that is curable by an external stimulus, and/or by shrinking the printing plate attachment means onto the plate cylinder 10. Thus, the printing plate attachment means being formed as a sleeve has the advantage of a fast and easy installation and facilitates refurbishing of a plate cylinder 10.

One of the advantages of using an adhesion layer 20 including adhesion elements 25 (printing plate attachment means) mentioned above is that air bubbles can be prevented from remaining between the plate cylinder 10 and the printing plate 50. This advantageous characteristic particularly avoids printing errors that may otherwise be caused due to trapped air bubbles.

This advantageous property of the adhesion layer’s adhesion surface side 23 has been tested using the air bleed test method described in US 6,772,686 B2 and starting at column 18 as a basis, the salient portions of which are hereby incorporated by reference. During testing, the samples have been pressed onto the surface of the testing apparatus by means of a glass plate using a weight of 4 kg over an area size of 107 mm × 200 mm in order to simulate the escape of air during the mounting step of the adhesion layer’s adhesion surface side 23 to a printing plate 50 or to a plate cylinder 10. The glass plate has a weight of 380 g, such that a pressure of (380 g + 4 kg)/(107 mm × 200 mm) ≈ 0.2 N/cm2 was exerted. This test resulted in the following air bleed values:
Sample 1
   Air bleed, 0.07 bar: 7 qnl/h
   Air bleed, 0.14 bar: 28 qnl/h
Sample 2
   Air bleed, 0.07 bar: 10 qnl/h
   Air bleed, 0.14 bar: 31 qnl/h

In particular for high pressures, the formation of air channels have been observed. It is assumed that air was collected in and escaped through these channels. After turning off the air pressure, no air bubble was visible anymore and a continuous attachment of the adhesion layer has been observed.

In any of the embodiments discussed above, an adhesion plate cylinder 1 or an adhesion printing plate can be provided that is configured for multiple applications and removals of flexographic printing plates 50. Further, the microstructure of the adhesion surface side 23 can easily be cleaned. As a result, an adhesion plate cylinder 1 with an adhesion layer 20 according to this disclosure provides significant advantages, in particular in comparison to the attachment of a flexographic printing plate 50 via a double-sided adhesive film.

Reference Signs

| | |
|---|---|
| 1 | adhesion plate cylinder |
| 10 | plate cylinder |
| 11 | inner circumferential surface |
| 12 | outer circumferential surface |
| 20 | adhesion layer |
| 21 | carrier sheet |
| 22 | mounting surface side |
| 23 | adhesion surface side |
| 23′ | adhesion surface of one end face |
| 24 | base |
| 24 a | base surface |
| 25 | adhesion element |
| 26 | elongated body |
| 27 | head portion |
| 28 | end face |
| 29 | neck portion |
| 30 | silicone layer |
| 31 | adhesive surface |
| 40 | double sided adhesive film |
| 50 | flexographic printing plate |
| L | longitudinal axis |

1-19. (canceled)

20. An adhesion plate cylinder for multiple applications and removals of flexographic printing plates, comprising:
a plate cylinder, the plate cylinder having an outer circumferential surface and a longitudinal axis; and
an adhesion layer, the adhesion layer being attached to the plate cylinder and comprising:
a carrier sheet with a mounting surface side facing the plate cylinder and an adhesion surface side facing radially outwards in relation to the longitudinal axis, and
a plurality of adhesion elements,
wherein each adhesion element includes an elongated body extending radially outwards in relation to the longitudinal axis and an end face for attaching a printing plate by an adhesive bond, and
wherein the end faces of the adhesion elements define the adhesion surface side.

21. The adhesion plate cylinder according to claim 20, wherein the elongated body of each adhesion element has a diameter of 10 to 80 microns, and a height of 50 to 150 microns.

22. The adhesion plate cylinder according to claim 20, wherein the elongated body has a flared head portion with a maximum diameter of 30 to 80 microns, and further wherein the head portion comprises a substantially flat end face or a concave end face.

23. The adhesion plate cylinder according to claim 22, wherein the elongated body further comprises a neck portion adjacent to the head portion, the neck portion having a diameter of 10 to 35 microns.

24. The adhesion plate cylinder according to claim 20, wherein the carrier sheet comprises 3,000 to 300,000 adhesion elements per square centimeter.

25. The adhesion plate cylinder according to claim 20, wherein the end faces of the adhesion elements that define the adhesion surface side cover 30% to 50% of a surface of the carrier sheet.

26. The adhesion plate cylinder according to claim 20, further comprising:
a silicone layer comprising two sides, the silicone layer arranged between the adhesion layer and the plate cylinder, and the sides of the silicone layer mounted to the adhesion layer and the plate cylinder with an adhesive bond, wherein the adhesive bond between the silicone layer and the plate cylinder comprises a double-sided adhesive film.

27. The adhesion plate cylinder according to claim 20, further comprising:
a double-sided adhesive film or a double-sided adhesive layer, wherein the double-sided adhesive film or double-sided adhesive layer is made of silicone and arranged between the adhesion layer and the plate cylinder, and further wherein the double-sided adhesive layer is a foam layer.

28. The adhesion plate cylinder according to claim 20, wherein the adhesion layer comprises a polymer.

29. The adhesion plate cylinder according to claim 28, wherein the polymer is selected from the group consisting of a polysiloxane, a polyurethane, and an acrylate.

30. A method of producing an adhesion plate cylinder with a reusable adhesion surface side for mounting a flexographic printing plate, comprising the steps of:
providing a plate cylinder comprising a longitudinal axis and an outer circumferential surface; and
mounting an adhesion layer to the plate cylinder using an adhesive bond so that a carrier sheet of the adhesion layer faces the plate cylinder,
wherein a plurality of adhesion elements define the reusable adhesion surface side and extend from the carrier sheet radially outwards in relation to the longitudinal axis, and
wherein each of the adhesion elements includes an end face for attaching a flexographic printing plate by an adhesive bond.

31. The method according to claim 30, wherein the adhesive bond is established by an adhesive surface of the adhesion layer, an adhesive surface of the plate cylinder, or a double-sided adhesive film.

32. The method according to claim 30, further comprising the step of:
mounting a silicone layer to the plate cylinder before the step of mounting an adhesion layer.

33. The method according to claim 32, wherein the step of mounting the silicone layer includes establishing an adhesive bond using an adhesive surface of the silicone layer, an adhesive surface of the plate cylinder, or a double-sided adhesive film.

34. The method according to claim 32, wherein the step of mounting the adhesion layer includes establishing an adhesive bond using an adhesive surface of the adhesion layer, an adhesive surface of the silicone layer, or a double-sided adhesive film.

35. A printing plate attachment for removably attaching a printing plate to an adhesion plate cylinder, comprising:
an adhesion layer that comprises:
a carrier sheet with a mounting surface side and an adhesion surface side; and
a plurality of adhesion elements,
wherein each adhesion element includes an elongated body protruding from the carrier sheet and an end face for attaching a printing plate by an adhesive bond,
wherein the end faces of the adhesion elements define the adhesion surface side, and
wherein the adhesion layer is formed as a foil.

36. The printing plate attachment according to claim 35, wherein the adhesion layer is formed as a mounting sleeve that is configured to be mounted onto a plate cylinder.

37. A method of refurbishing a plate cylinder, comprising:
applying the printing plate attachment of claim 35 to a plate cylinder.

38. An adhesion printing plate, comprising:
a printing plate; and
an adhesion layer that comprises:
a carrier sheet with a mounting surface side facing the printing plate and an adhesion surface side facing away from the printing plate; and
a plurality of adhesion elements,
wherein each adhesion element includes an elongated body protruding from the carrier sheet and an end face for attachment to a plate cylinder by an adhesive bond, and
wherein the end faces of the adhesion elements define the adhesion surface side.

39. The adhesion printing plate according to claim 38, wherein the elongated body of each adhesion element has a diameter of 10 to 80 microns, and a height of 50 to 150 microns.

40. A printing process using an adhesion layer, comprising the steps of:
providing an adhesion layer that comprises:
a carrier sheet with a mounting surface side and an adhesion surface side; and
a plurality of adhesion elements,
wherein each adhesion element includes an elongated body protruding from the carrier sheet and an end face, and
wherein the end faces of the adhesion elements define the adhesion surface side;
mounting the mounting surface side of the carrier sheet to one of a printing plate and a plate cylinder by an adhesive bond;
attaching the adhesion surface side to the other one of the printing plate and the plate cylinder by an adhesive bond; and
performing a printing step using the printing plate, the performing step conducted after the steps of mounting and attaching.
